(19) United States
(12) Patent Application Publication
(10) Pub. No.: US 2015/0178996 A1
(43) Pub. Date: Jun. 25, 2015

(54) Method and System for Social Monitoring of a Parking Facility

(71) Applicants: CHARLIE YOUAKIM, CHARLOTTE, NC (US); ROBERT YOUAKIM, CHARLOTTE, NC (US); KHRISTIAN GUTIERREZ, CHARLOTTE, NC (US)

(72) Inventors: CHARLIE YOUAKIM, CHARLOTTE, NC (US); ROBERT YOUAKIM, CHARLOTTE, NC (US); KHRISTIAN GUTIERREZ, CHARLOTTE, NC (US)

(21) Appl. No.: 14/120,431

(22) Filed: Jun. 18, 2013

(51) Int. Cl. G07B 15/00; G06Q 40/00

(52) U.S. Cl. CPC G07B 15/00; G06Q 40/12

(57) ABSTRACT

A system for the social monitoring of parking, comprising a user interface on a mobile device or on-site parking hardware where the general public can access real-time data of the authorized and unauthorized activity of motorists parked in specific parking stalls or locations in the vicinity. The system provides a means for reporting unauthorized activity to the parking provider (an operator or parking owner of a facility). The parking provider will also have real-time access to the information being reported. The parking provider will receive information about which motorists are in violation of any rules and regulations, and thus target where to issue citations or immobilize the vehicle as a penalty.

This application claims benefit of and priority to U.S. Provisional Application No. 61/759,736, filed Feb. 1, 2013, and is entitled to that filing date for priority in whole or in part.

### FIELD OF INVENTION This invention relates to a system and method for monitoring of a parking facility through social networks and interfaces.

### BACKGROUND OF THE INVENTION

Parking is the act of stopping a moving vehicle and leaving it unoccupied for a specific period of time. Parking on one or both sides of a road is commonly permitted, though often with restrictions. Motorists also use parking facilities such as surface lots, garages and multi-level decks on an hourly, daily, monthly or other basis to park their respective vehicles.

In congested urban areas, parking of motor vehicles is often time-consuming and expensive. It is common for parking stalls and parking locations to have fees for renting or reserving the space for a specific period of time. This dynamic can be seen with on-street parking where meter systems and electronic payment systems enable various means for motorists to park motor vehicles. Similar methods are used in surface lots and garage parking systems, where vehicles are required to pay for the use of a parking stall through a variety of payment methods.

It is common to have certain restrictions in place to control the activity and flow of motorist parking. Communication about the status of a parking session takes the form of notices, e.g., fixed to a nearby wall and/or road markings. Parkers often overstay their payment period, or do not pay at all for their stay. Non-payment for any portion of a parking stay costs parking facility operators and owners substantially. Fines and deterrents are enforced to motorists that violate the stated rules and regulations. The deterrent can take physical forms such as vehicle immobilization, such as by a wheel clamp, and non-physical forms, such as levying parking charges to the registered vehicle owners.

Parking control and enforcement is primarily an issue in relatively densely populated areas where the supply and demand dynamic for parking spaces makes parking facilities coveted. In these locations, monitoring and enforcement is conducted by corresponding professionals and firms specializing in parking management.

In order to deter such illicit activity, many different methods of monitoring parking stalls and locations have been developed. Such methods include, but are not limited to, mechanical systems (e.g., ground loop detectors, ultrasonic detectors, and the like) and manual inspection. These systems are often costly, unreliable and inefficient. Most importantly, monitoring systems in the current marketplace rely on paid or contracted employees to carry the burden of inspecting parking stalls to determine if a parker is in violation of non-payment. It is therefore desirable to provide a low cost, reliable and efficient system for monitoring parking activity in a parking stall.

### SUMMARY OF THE INVENTION

In various embodiments, the present invention provides a system and process for the social monitoring of parking through a user interface on a mobile device or on-site parking hardware where the general public (i.e. a non-contracted employee of a parking facility or municipal parking meter system, for instance) can access real-time data of the authorized and unauthorized activity of motorists parked in specific parking stalls or locations in the vicinity. In particular, the system provides a means for reporting unauthorized activity to the parking provider (an operator or parking owner of a facility). The parking provider will also have real-time access to the information being reported by the participant from the general public. The parking provider will now receive information about which motorists are in violation of any rules and regulations and target where to issue citations or immobilize the vehicle as a penalty.

In some embodiments, the success or failure of the ticketing operation is then optionally reported back to the public entity who reported the violation of the vehicle located in the parking stall. Providing this feedback to the public entity encourages future reporting of illicit activity creating incentive for additional reporting.

In other embodiments, along with this feedback mechanism, there are other modes in which the general public has incentive to join the system to social monitor parking at specified facilities and locations. One such mode is that finding parking is often frustrating. In busy periods of the day, the demand for a parking stall is greater than the supply of open spaces making parking more difficult. If a member of the general public is having difficulty finding an open parking stall, they will become frustrated and will find satisfaction in reporting an unauthorized use of an otherwise open parking stall using the parking monitor system.

In additional embodiments, another way of encouraging public use of the social parking monitoring system includes an optional prize or reward for a successful report of unauthorized usage of a parking stall. For example, the optional reward could include, but is not limited to, free parking validations, parking discount validations, monetary rewards, or gifts in exchange for successful reporting of violators.

In yet further embodiments, as the number of participants in the social monitoring increases, the rate of offenders will decrease. In addition, having the general public engaged in the monitoring of rule violations encourages motorists to follow the outlined rules and regulations to avoid receiving a citation or other disciplinary action. For instance, adding social pressure through the availability of real-time parking session information to the general public will act as a deterrent to illicit activity. This ultimately leads to parking operations that are more efficient, thereby decreasing motorist frustration, increasing revenue for the parking providers and reducing costs associated with parking enforcement.

Accordingly, the invention provides a completely new way of incorporating social pressure and policing to parking monitoring and enforcement. The invention, in some embodiments, comprises a process allowing the parking provider to establish efficient pathways for controlling and monitoring their parking facilities. Additionally, the invention, in some embodiments, operates on cloud computing technology allowing for real-time information and communication to the general public from anywhere in the world with an Internet connection.

In a further embodiment, the parking facility management system processor is further configured to execute a rewards component. The rewards component receives identifying information about the user via the mobile application, mobile device, or parking device and based on the identifying information, determines if the user is a qualifying rewards program member. As the user reports successful violations to the parking provider they will receive reward points in return. The accumulated points would then be redeemable or exchanged for rewards.

Various embodiments of the parking facility management system allow for at least the following functions:
1. Public access to authorized and unauthorized activity of motorists parked in specific parking stalls or locations through the use of any mobile application, mobile web or parking hardware device.
2. A mechanism for reporting unauthorized activity through above mentioned interfaces.
3. Confirmation of success of failure is sent back to the source of the violation report for action taken against a motorist who was in violation of a rule or regulation.

### DESCRIPTION OF THE DRAWINGS

FIG. 1 shows a view of a system in accordance with an embodiment of the present invention.

FIG. 2 shows another view of a system in accordance with an embodiment of the present invention.

### DETAILED DESCRIPTION OF EXEMPLARY EMBODIMENTS

In various embodiments, the present invention provides a process and system for the social monitoring of parking, comprising a user interface on a mobile device or on-site parking hardware where the general public (e.g., a non-contracted employee of a parking facility or municipal parking meter system) can access real-time data of the authorized and unauthorized activity of motorists parked in specific parking stalls or locations in the vicinity. In particular, the system provides a means for reporting unauthorized activity to the parking provider (an operator or parking owner of a facility). The parking provider will also have real-time access to the information being reported by the participant from the general public. The parking provider will receive information about which motorists are in violation of any rules and regulations and target where to issue citations or immobilize the vehicle as a penalty.

It is to be appreciated that, in accordance with one or more embodiments or implementations described in this disclosure, users can opt-out of providing personal information, demographic information, location information, proprietary information, sensitive information, or the like in connection with data gathering aspects from parking facilities. Moreover, it is assumed that data collected, received, or transmitted is anonymous wherever possible.

As will be seen from the following description, in one aspect, the invention relates to an integrated set of methodologies, equipment, software applications executed on computer systems, and network infrastructure associated with a cloud-based parking facility management system. The following terms, as used herein, have the following meanings:

Parking Violation: The act of parking a motor vehicle in a restricted place or for parking in an unauthorized manner.

Parking Device: In some embodiments, these devices may be kiosk stations that are designed for multiple applications, but are generally located at the unattended entry and exits of a parking facility. In some embodiments, these devices may be portable, e.g., they may be a device that includes an application such as a smartphone, a tablet, a laptop, or a mobile phone. Parking devices communicate with the parking facility management system in the cloud to integrate all software applications, executed on a computer system of the parking facility or a remote computer system, with programs of parking facility management system itself.

Social Networking Service: An online service, platform, or site that focuses on facilitating the building of social networks or social relations among people who, for example, share interests, activities, backgrounds, or real-life connections. Examples of social networks include, but are not limited to, the following: Facebook; Twitter; LinkedIn; MySpace; Yelp; blogs or RSS feeds; or other similar Internet or web-based platforms.

Social Graph: In the Internet context, it is a sociogram—a graph that depicts the personal relationships of Internet users.

Cloud Computing: “Cloud computing” and “in the cloud” refers to the use of remote computational resources creating an omnipresent computer network allowing for high connectivity and low latency. Because the cloud is an underlying delivery mechanism, cloud based applications and services may support any combination of software applications or services executed on a computer system.

Rewards Program: Loyalty programs are structured marketing efforts that reward passengers, and therefore encourage, loyal buying behavior. Customers accumulate points that can be redeemed for rewards.

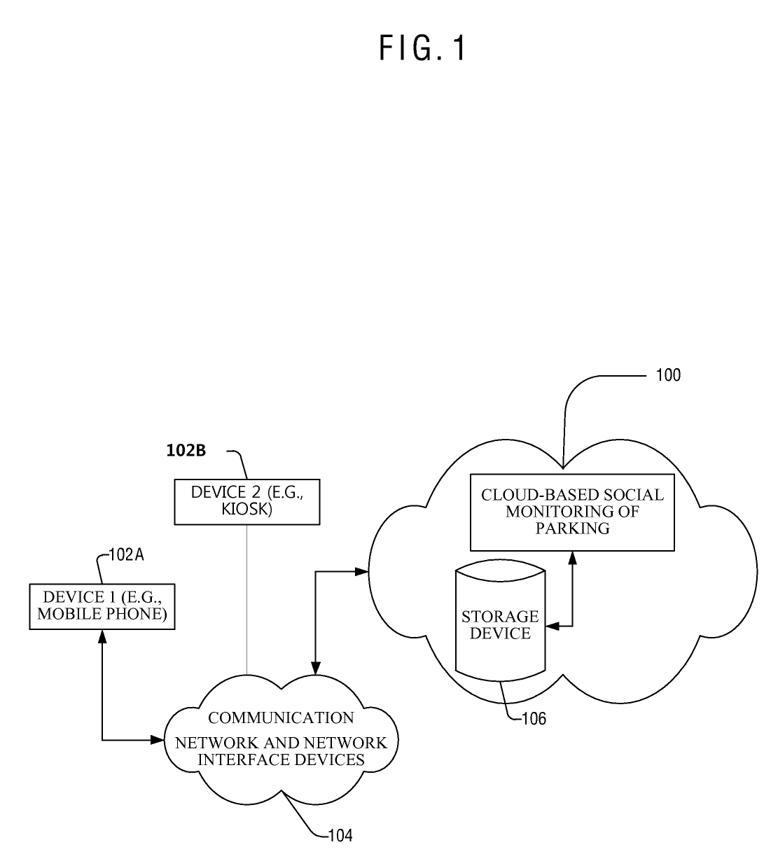

As shown in FIG. 1, the system 100 may include a variety of software or machine-executable components embodied within machine(s), e.g., embodied in one or more computer readable mediums (or media) associated with one or more machines. System 100 may be coupled to a storage device 106. In some embodiments, system 100 is implemented as a cloud computing system/network to facilitate the monitoring of parking spaces managed by system 100.

One or more devices such as device 1 102a and device 2 102b are coupled to system 100 via network infrastructure 104. Network infrastructure 104 includes a communication network (e.g., the Internet, a LAN, a WAN), and network interface devices (e.g., wireless data card, cellular data card, wired Ethernet card). Parking devices 102a, 102b may transmit and receive various types of information to and from system 100. This information may be stored in storage device 106 or in a storage device within one or more of the parking devices 102a, 102b. The communication of this information enables system 100 to, among other things, allow the public community to monitor parking spaces and report the motorists that are in violation of a parking rule or violation to the parking providers. Other components/services/functionalities that system 100 may provide include, for example, loyalty rewards and user reporting history.

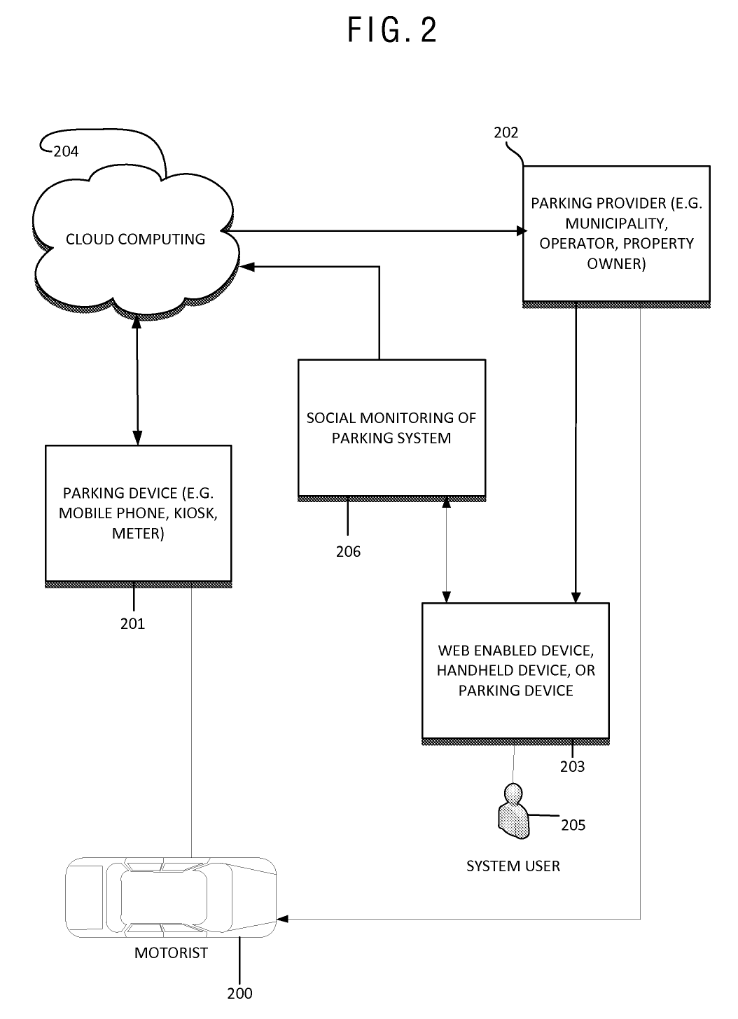

In some embodiments, device 1 102a is a stationary device such as a kiosk station or entry/exit station that is located at a fixed location within a parking facility. In some embodiments, device 2 102b is a mobile device such as a smartphone, a tablet, a laptop computer, or a mobile phone. Each of devices 1 and 2 (102a, 102b) and the cloud-based system and process for social monitor of parking spaces 100 includes one or more computer system components as described with respect to FIG. 2 below. In the case of a mobile device 102b such as a smartphone, the device may include an application (“app”) that interfaces between a user of the device 102b in a parking facility and one or more components of the system 100.

In some embodiments, parking devices 102a or 102b transmit information collected from a user's parking stay at a dedicated property which is available to the general public through the system 100. This information may be stored in a database on a storage device associated with either or both of the parking devices 102a, 102b and the system 100. In this manner, system 100 is able to communicate information regarding whether a motorist has successfully and appropriately parked in a given location. Through system 100, the general public would then be able to transmit information back to the parking operator that a motorist is in violation of a rule or regulation.

The parking devices 102a, 102b are coupled to various components on the cloud network in order to keep track of this and other parking user information. For example, system 100 retains information on transient parkers. In some embodiments, the retained customer information includes the type of parking stay (daily or event) and the duration of each stay.

As seen in FIG. 2, the process begins when a motorist 200 enters a parking stall at a dedication parking facility or location. The motorist would initiate a parking transaction through any parking device 201. This could include a variety of payment devices including, but not limited to: mobile phones, web-enabled devices, kiosks and meters. A general system user 205 will have access to active and inactive parking session information. Through the social monitoring of parking system 206, the user 205 has the ability to verify in real-time that a vehicle parked in a stall has indeed paid for, and has the right to the current time in that stall. Using web enabled device or handheld, or a parking device on the facility 203, the user can report unauthorized parking sessions to the parking provider 202. A parking session may be deemed unauthorized if an occupied stall shows as unpaid in the system 206.

With continued reference to FIG. 2, the parking provider 202 receives the violation report transmitted from the system user 205, along with the system user identification information and history and has the option to deploy an employee to confirm that the vehicle in question 200 is indeed in violation of a rule or regulation and take necessary action, for example, issue a citation.

Both the parking provider 202 and system monitoring provider will have the ability to reward users of system 206 for successfully reporting a payment violation of a parking stall that resulted in the issuance of a citation. Similarly, the parking provider 202 can choose to limit the receipt of violation notifications from a given user of the system 206, if a notification does not result in the issuance of a citation or the user is abusing the system with false transmissions of motorist 200 violations.

If the parking provider 202 successfully tickets an unauthorized motorist 200 reported by a system user 205, said system user will receive a message from Social Monitoring of Parking System 206 notifying them of the successful penalty.

A cloud-based parking facility management system and devices thereof is disclosed in the patent application (U.S. patent application Ser. No. 12/520,849) attached as an appendix hereto, and incorporated herein by specific reference, which may be modified in the manner described above to implement the systems and processes described above.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

Accordingly disclosed herein is a social parking monitor system where the general public is provided an interface through a mobile device or on-site parking hardware for detecting and reporting unauthorized parking activity in a parking stall. The participants coming from the general public will be identifiable through registration or via an embedded identifier. Parking facility operators use the reported information to improve their monitoring routes and to provide feedback and optional rewards to participants.

1. A system for social monitoring of a parking facility, comprising:
one or more devices located in proximity to at least one parking facility, each device comprising a processor or microprocessor and in electronic communication through a network with one or more parking system servers;
wherein a user interacting with said one or more devices can determine in real-time if a vehicle parked in said at least one parking facility is in compliance with facility rules regarding payment, and report said vehicle in real-time to the parking system servers if the vehicle is not in compliance.

2. The system of claim 1, wherein said one or more devices comprises a kiosk.

3. The system of claim 1, wherein said one or more devices comprises a mobile computing device.
